(19) United States
(12) Patent Application Publication
(10) Pub. No.: US 2016/0342191 A1
(43) Pub. Date: Nov. 24, 2016

(54) CPU FREQUENCY SCALING APPARATUS AND METHOD

(71) Applicant: ELECTRONICS AND TELECOMMUNICATIONS RESEARCH INSTITUTE, Daejeon (KR)

(72) Inventors: Jin-Ho ON, Jeonju-si (KR); Sung-Ik JUN, Daejeon (KR)

(21) Appl. No.: 15/006,737

(22) Filed: Jan. 26, 2016

(30) Foreign Application Priority Data
May 22, 2015 (KR) 10-2015-0071526

(51) Int. Cl. G06F 1/32

(52) U.S. Cl. CPC G06F 1/3234; G06F 1/324

(57) ABSTRACT

CPU frequency scaling apparatus and method, which can select an optimal frequency based on a preset power versus efficiency table for a CPU when selecting the operating frequency based on the average load of the overall system during a specific time interval. The CPU frequency scaling apparatus includes a table generation unit for generating, for all cores, a power versus efficiency table, based on available frequencies for respective cores and power consumption values depending on loads at each frequency, an average load measurement unit for calculating an average load on all the cores, and a frequency determination unit for searching the power versus efficiency table for an optimal frequency, based on load information calculated by the average load measurement unit and current power consumption of all the cores, and determining a found optimal frequency to be a new operating frequency.

### CROSS REFERENCE TO RELATED APPLICATION

This application claims the benefit of Korean Patent Application No. 10-2015-0071526, filed May 22, 2015, which is hereby incorporated by reference in its entirety into this application.

### BACKGROUND OF THE INVENTION

1. Technical Field

The present invention generally relates to a Central Processing Unit (CPU) frequency scaling apparatus and method and, more particularly, to an apparatus and method that dynamically scale the CPU frequency based on the power efficiency of a CPU.

2. Description of the Related Art

At the current time, in which the use of Information Technology (IT) devices is accounting for an increasing proportion of global power consumption, research leading to the reduction of energy consumption of IT devices has been actively conducted.

For a method (e.g. CPU DVFS: Dynamic Voltage and Frequency Scaling) for reducing power consumption by controlling the frequency and voltage of a CPU, which is a core part of IT devices, various governors have been developed via research that has already been conducted over several years, and various hardware platforms (for mobile/servers) have been introduced and used as methods for solving the problem of energy consumption.

For example, representative CPU DVFS governors based on Linux are given as follows.

The performance governor locks the operating frequency of a CPU at the maximum frequency thereof. The powersave governor locks the CPU operating frequency at the minimum frequency thereof. The OnDemand governor, which is a scheme for dynamically setting the CPU operating frequency depending on the workload during the execution of a CPU, is configured such that, for a load having a specific threshold or more, the operating frequency is directly set to the maximum frequency, and the frequency gradually steps down depending on the workload. The interactive governor, which is a scheme for dynamically setting the CPU operating frequency depending on the workload during the execution of a CPU, is configured such that, for a load that meets or exceeds a specific threshold, the next highest or next lowest frequency is set in steps as the CPU operating frequency. The hotplug governor (load-averaging governor), which is intended to solve the problem of frequency imbalance between cores, which may occur in a multi-core structure, selects the optimized frequency by classifying CPU loads.

Such governors exhibit performance optimized for specific domains, but it is difficult to use the governors as general-purpose governors due to the following problems.

The OnDemand governor is a scheme for selecting the optimal frequency depending on the load, but the frequency depending on the load does not reflect multi-core characteristics. Further, the time of application of this governor is too late, so that the OnDemand governor exhibits performance similar to that of the performance governor, which does not use DVFS technology, or exhibits more inefficient results than the performance governor due to the amount of overhead in specific situations.

The interactive governor is configured to gradually change the frequency, thus exhibiting better performance than that of the OnDemand governor in situations in which the amount of CPU usage changes sharply. However, the interactive governor does not solve the problem of imbalance occurring due to a scheme in which the operating frequency is allocated based on the highest load among the loads on the cores in a multi-core structure.

The hotplug governor supports a multi-core structure and selects a relatively optimal frequency during the execution of a CPU, but is problematic in that it tends to select a higher frequency, at which power versus efficiency is deteriorated, when at the boundary between selectable frequencies.

As preceding technologies related to the present invention, Korean Patent Application Publication No 2013-0040485 (entitled “Apparatus and Method for Controlling CPU in a Portable Terminal”) and Korean Patent Application Publication No. 2011-0043193 (entitled “Apparatus and Method for Power Control of Central Processing Unit in a Multi-Core System”) are disclosed.

### SUMMARY OF THE INVENTION

Accordingly, the present invention has been made keeping in mind the above problems occurring in the prior art, and an object of the present invention is to provide a CPU frequency scaling apparatus and method, which can select an optimal frequency based on a preset power versus efficiency table for a CPU when selecting the operating frequency based on the average load of the overall system during a specific time interval.

In accordance with an aspect of the present invention order to accomplish the above object, there is provided a Central Processing Unit (CPU) frequency scaling apparatus, including a table generation unit for generating, for all cores, a power versus efficiency table, based on available frequencies for respective cores and power consumption values depending on loads at each frequency; an average load measurement unit for calculating an average load on all the cores; and a frequency determination unit for searching the power versus efficiency table for an optimal frequency, based on load information calculated by the average load measurement unit and current power consumption of all the cores, and determining a found optimal frequency to be a new operating frequency.

The frequency determination unit may determine the optimal frequency found from the power versus efficiency table to be the new operating frequency, based on the load information calculated by the average load measurement unit and the current power consumption of all the cores depending on whether a powersave governor has been activated.

The frequency determination unit may be configured to, if the powersave governor has been activated, determine, based on the load information calculated by the average load measurement unit and the current power consumption, a certain frequency to be the new operating frequency, wherein the certain frequency exhibits power efficiency, which matches the load information and the current power consumption, in the power versus efficiency table.

The frequency determination unit may be configured to select a single candidate frequency from the power versus efficiency table based on a current operating frequency and current power consumption, compare power efficiencies of the candidate frequency and frequencies lower than the candidate frequency, and if the candidate frequency is determined to be optimal, determine the candidate frequency to be the new operating frequency.

The frequency determination unit may be configured to select a single candidate frequency from the power versus efficiency table based on a current operating frequency and current power consumption, compare power efficiencies of the candidate frequency and frequencies lower than the candidate frequency, and if a frequency having better power efficiency is determined to be present among the lower frequencies, determine a corresponding lower frequency to be the new operating frequency.

The frequency determination unit may be configured to, if the powersave governor has not been activated, set an operating frequency of each core to a maximum frequency.

The frequency determination unit may apply the new operating frequency to each core through a CPU driver.

The table generation unit may be configured to, if the power versus efficiency table is not present in a database when the corresponding apparatus starts to operate, generate a power versus efficiency table and store the generated power versus efficiency table in the database.

The average load measurement unit may calculate an average load on all the cores during a predetermined period of time, based on a working time and an idle time of the corresponding apparatus.

In accordance with another aspect of the present invention order to accomplish the above object, there is provided a Central Processing Unit (CPU) frequency scaling method, including generating, by a table generation unit, for all cores, a power versus efficiency table, based on available frequencies for respective cores and power consumption values depending on loads at each frequency; receiving, by a frequency determination unit, an average load on all the cores calculated by an average load measurement unit depending on whether a powersave governor has been activated; and searching, by the frequency determination unit, the power versus efficiency table for an optimal frequency, based on the average load and current power consumption of all the cores, and determining a found optimal frequency to be a new operating frequency.

Receiving the average load on all the cores may include receiving the average load on all the cores calculated by the average load measurement unit if the powersave governor has been activated.

Determining to be new operating frequency may include selecting a single candidate frequency from the power versus efficiency table, based on a current operating frequency and current power consumption; comparing power efficiencies of the candidate frequency and frequencies lower than the candidate frequency; and if the candidate frequency is determined to be optimal as a result of the comparison, determining the candidate frequency to be the new operating frequency.

Determining to be the new operating frequency may include selecting a single candidate frequency from the power versus efficiency table, based on a current operating frequency and current power consumption; comparing power efficiencies of the candidate frequency and frequencies lower than the candidate frequency; and if a frequency having better power efficiency is determined to be present among the lower frequencies as a result of the comparison, determine a corresponding lower frequency to be the new operating frequency.

The CPU frequency scaling method may further include applying, by the frequency determination unit, the new operating frequency to each core through a CPU driver.

Generating the power versus efficiency table may include, if the power versus efficiency table is not present in a database when a corresponding apparatus starts to operate, generating a power versus efficiency table.

The average load on all the cores may be calculated based on a working time and an idle time of a corresponding apparatus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a hardware system to which the present invention is applied;

FIG. 2 is a configuration diagram showing a CPU frequency scaling apparatus according to an embodiment of the present invention;

FIG. 3 is a diagram illustrating an algorithm for generating a power versus efficiency table in the table generation unit shown in FIG. 2,

FIG. 4 is a diagram illustrating a power versus efficiency table stored in the database shown in FIG. 2;

FIG. 5 is a flowchart showing a CPU frequency scaling method according to an embodiment of the present invention;

FIG. 6 is a flowchart illustrating the detailed procedure of the frequency determination step shown in FIG. 5;

FIG. 7 is a graph showing power efficiency analysis data for each frequency; and

FIG. 8 is a diagram showing a computer system in which the embodiment of the present invention is implemented.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

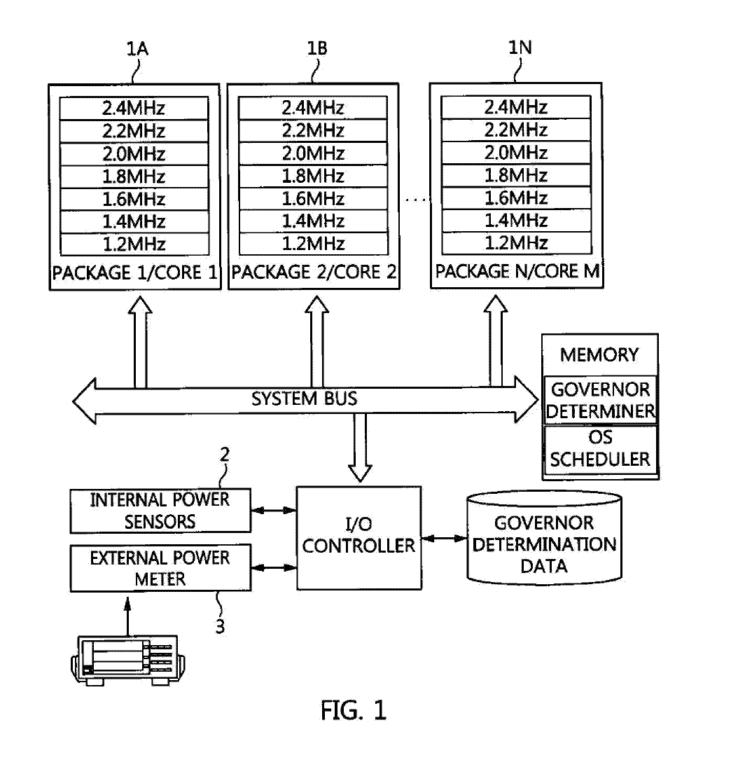

FIG. 1 is a diagram illustrating a hardware system to which the present invention is applied.

The hardware system to which the present invention is applied is based on a multi-core system having one or more packages 1A, 1B, . . . , 1N which are capable of setting various operating frequencies, wherein each package has one or more cores.

The hardware system to which the present invention is applied may receive a power value, which is used when the CPU experiences a specific load, from a measuring instrument 2 in an Operating System (OS) stage (e.g., Running Average Power Limit: RAPL) or an external measuring instrument 3.

The hardware system to which the present invention is applied is aimed at a CPU to which a CPU DVFS function, which enables the operating frequency of the CPU to be variably scaled in the kernel of the OS, is applicable.

On such multi-core hardware, all cores are executed at the same selected frequency by the present invention.

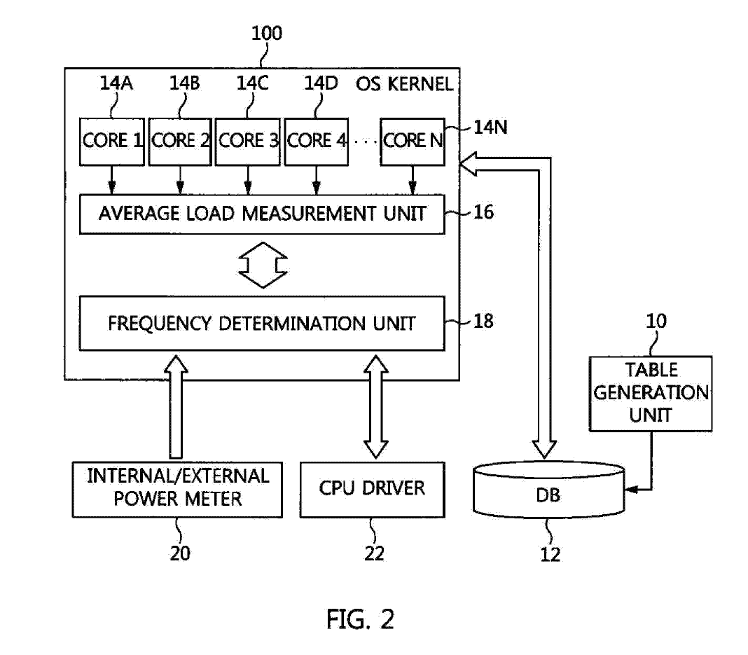

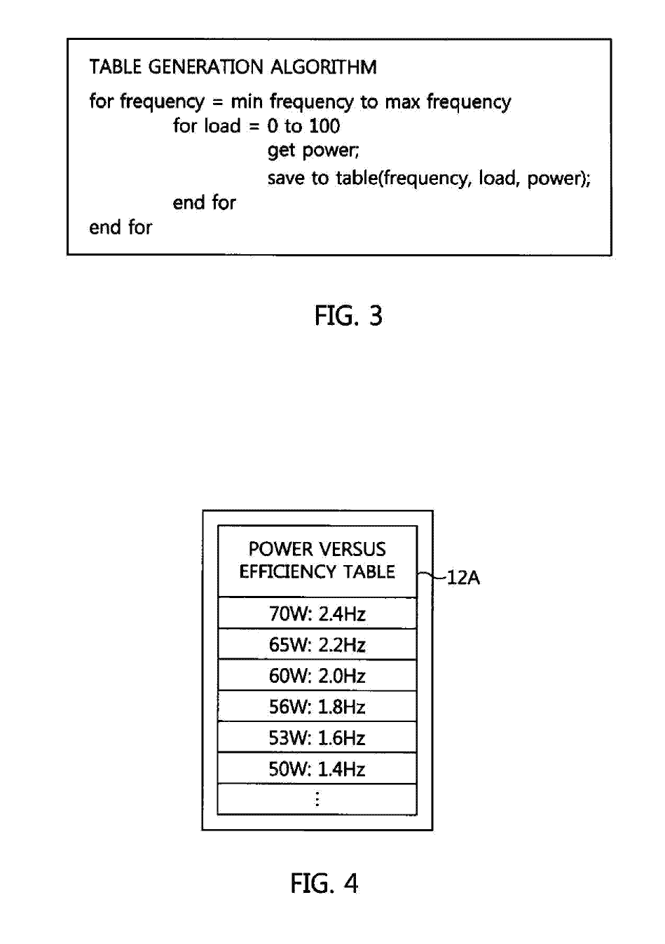

FIG. 2 is a configuration diagram showing a CPU frequency scaling apparatus according to an embodiment of the present invention, FIG. 3 is a diagram illustrating an algorithm for generating a power versus efficiency table in the table generation unit shown in FIG. 2, and FIG. 4 is a diagram illustrating a power versus efficiency table stored in the DB shown in FIG. 2.

The CPU frequency scaling apparatus according to the embodiment of the present invention includes a table generation unit 10, a database (DB) 12, an average load measurement unit 16, and a frequency determination unit 18.

A table generation unit 10 checks, for all cores 14A to 14N, available frequencies for respective cores, generates a table (i.e. power versus efficiency table) from power consumption values for loads ranging from 0 to 100 at each frequency, and stores the generated table in the DB 12. The power versus efficiency table is generally used for all the cores 14A to 14N. It may be understood that, in the specification of the present invention, each core corresponds to a CPU.

The table generation unit 10 may use a table generation algorithm, such as that illustrated in FIG. 3, so as to generate the power versus efficiency table.

Meanwhile, the table generation unit 10 may determine whether a power versus efficiency table is present in the DB 12 when the operation of the apparatus according to the embodiment of the present invention is initiated. If it is determined that no power versus efficiency table is present, the table generation unit 10 generates the above-described power versus efficiency table and stores it in the DB 12.

The DB 12 stores a power versus efficiency table 12a (see FIG. 4) generated by the table generation unit 10.

The DB 12 may store a powersave governor. Here, the powersave governor is intended to determine an optimal operating frequency based on the power versus efficiency table, and conforms to the frequency determination scheme of the frequency determination unit 18.

The average load measurement unit 16 and the frequency determination unit 18 may be regarded as being located in an OS kernel 100, together with multiple cores 14a to 14n.

The average load measurement unit 16 calculates the average load on all the cores 14a to 14n during a predetermined period of time, based on information such as the working time and idle time of the corresponding apparatus. The average load measurement unit 16 transmits information about the calculated load to the frequency determination unit 18.

The average load measurement unit 16 may be regarded as being controlled by the frequency determination unit 18.

The frequency determination unit 18 calls the average load measurement unit 16 and calculates the average load on all the cores 14A to 14N during a predetermined period of time.

Further, the frequency determination unit 18 determines, based on the load information calculated by the average load measurement unit 16 and the current power consumption of all the cores 14A to 14N, a certain frequency to be the operating frequency, wherein the certain frequency exhibits the power efficiency, which matches the load information and the current power consumption, in the power versus efficiency table 12A. Here, the current power consumption of all the cores 14A to 14N is calculated by an internal/external power meter 20.

Further, the frequency determination unit 18 applies the determined operating frequency to each core through a CPU driver 22, and updates the state of the corresponding core.

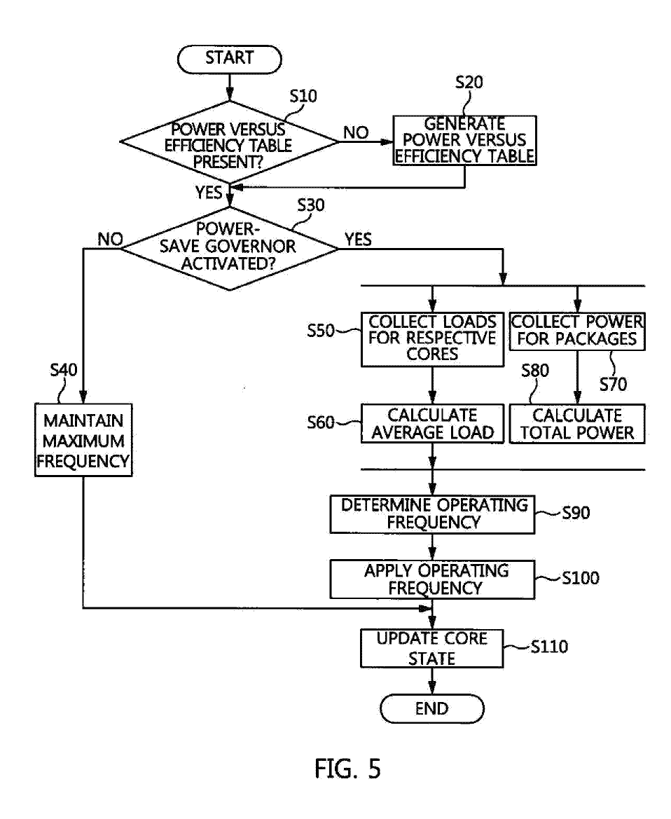

FIG. 5 is a flowchart showing a CPU frequency scaling method according to an embodiment of the present invention.

When the apparatus according to the embodiment of the present invention starts to operate, the table generation unit 10 determines whether a power versus efficiency table is present in the DB 12 at step S10.

If it is determined that no power versus efficiency table is present, the table generation unit 10 checks, for all cores 14A to 14N, available frequencies for respective cores, generates a power versus efficiency table from power consumption values for loads ranging from 0 to 100 at each frequency, and stores the power versus efficiency table in the DB 12 at step S20. The table generation unit 10 notifies the frequency determination unit 18 that the generation of the power versus efficiency table has been completed.

Then, the frequency determination unit 18 determines whether a powersave governor has been activated at step S30. Here, the method of determining whether the powersave governor has been activated may be implemented in such a way that, when a flag (not shown) indicating whether a powersave governor has been activated in the frequency determination unit 18 is set to “1”, the powersave governor is determined to be activated. Alternatively, when a powersave governor is stored in the DB 12, it may be determined that the powersave governor has been activated.

If it is determined that a powersave governor has not been activated, the frequency determination unit 18 sets the operating frequencies of respective cores 14A to 14N to the maximum frequency at step S40, and updates the states of all cores at step S110.

In contrast, if the powersave governor has been activated, the frequency determination unit 18 controls the average load measurement unit 16 so that it calculates the average load on all the cores 14A to 14N during a specific period of time (e.g. 1 second) at steps S50 and S60, and receives information about the calculated load. Simultaneously with this calculation, the frequency determination unit 18 receives the current power consumption of all of the cores 14A to 14N, which is calculated by the internal/external power meter 20 at steps S70 and S80.

Thereafter, the frequency determination unit 18 sets (selects), based on the calculated load information (average load) and the power consumption, the operating frequency to the frequency that exhibits the power efficiency, which matches the load information and the power consumption, in the power versus efficiency table 12A at step S90.

Thereafter, the frequency determination unit 18 applies the set operating frequency to respective cores 14A to 14N through the CPU driver 22 at step S100, and updates the states of all the cores at step S110.

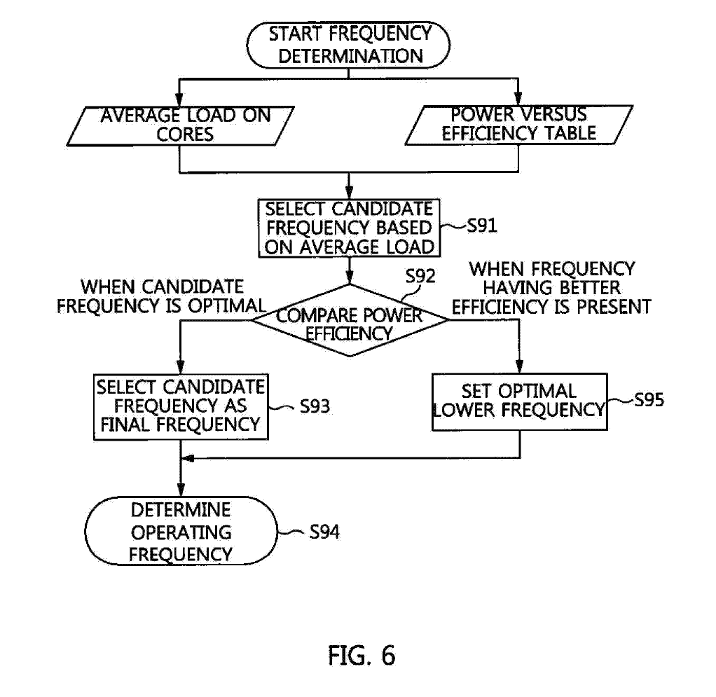

FIG. 6 is a flowchart illustrating a detailed procedure of the frequency determination step S90 shown in FIG. 5.

When the frequency determination is initiated, a precise frequency is determined based on both the average load on all cores 14A to 14N, determined in a previous stage, and the information in the power versus efficiency table.

Then, a single candidate frequency is selected from the power versus efficiency table, based on the current operating frequency and current operating power (power consumption) at step S91.

Thereafter, the power efficiencies of the selected candidate frequency and frequencies lower than the selected candidate frequency are compared at step S92.

As a result of the comparison, if the selected candidate frequency is determined to be optimal, the selected candidate frequency is selected as the final frequency at step S93, and the selected final frequency is determined to be a new operating frequency at step S94. That is, instead of the previous operating frequency, the final frequency selected at step S93 is set as the operating frequency.

In contrast, if any frequency having better power efficiency is determined to be present among the lower frequencies, the corresponding lower frequency is set as the optimal frequency at step S95, and the set optimal frequency is determined (selected) to be a new operating frequency.

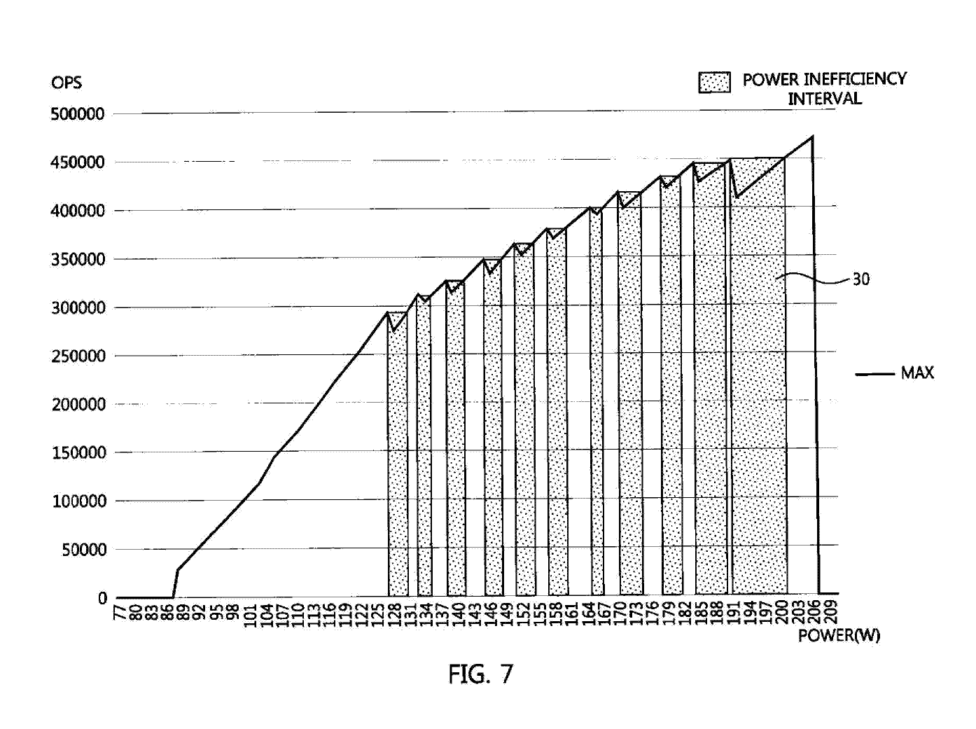

FIG. 7 is a graph illustrating power efficiency analysis data for each frequency, wherein the power efficiency analysis data for each frequency is based on actual measurement data by Specpower2008_ssj of a system in which a “Xeon E5-4620x2” CPU is installed.

In FIG. 7, reference numeral 30 denotes an interval in which the operating frequency is set to a higher frequency, at which more power is consumed to perform the same operation, i.e. in which operations are inefficiently performed (power inefficiency interval).

Owing to the effects of the present invention, the problem of such inefficient frequency allocation may be solved by optimizing the frequency allocation based on the power efficiency characteristics of a CPU.

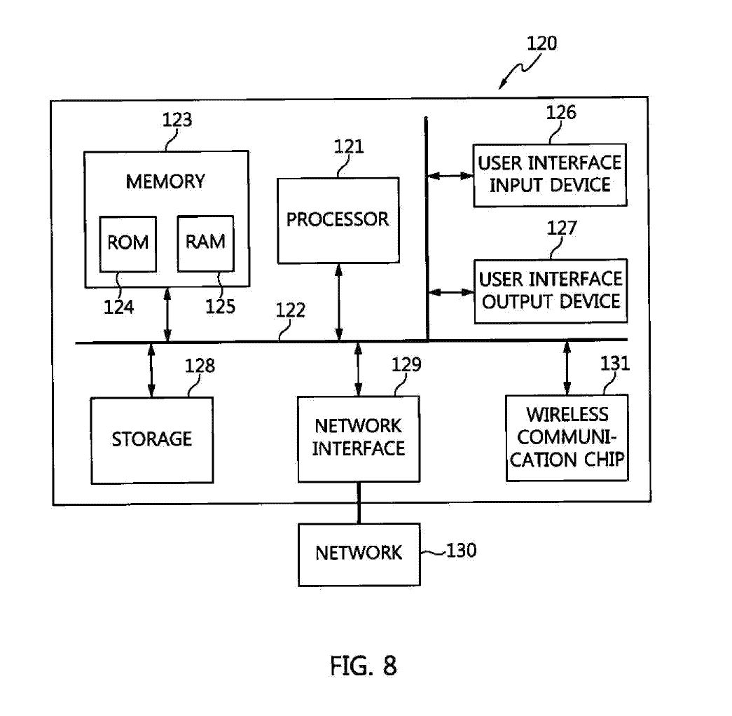

Meanwhile, the above-described embodiment of the present invention may be implemented in a computer system. As shown in FIG. 8, a computer system 120 may include one or more processors 121, memory 123, a user interface input device 126, a user interface output device 127, and storage 128, which communicate with each other through a bus 122. The computer system 120 may further include one or more network interfaces 129 connected to a network 130. Each processor 121 may be either a Central Processing Unit (CPU) or a semiconductor device for executing processing instructions stored in the memory 123 or the storage 128. Each of the memory 123 and the storage 128 may be any of various types of volatile or non-volatile storage media. For example, the memory 123 may include Read Only Memory (ROM) 124 or Random Access Memory (RAM) 125.

Further, when the computer system 120 is implemented in a small-sized computing device, in preparation for the Internet of Things (IoT) era, if an Ethernet cable is connected to the computing device, the computing device may function as a wireless sharer, so that a mobile device may be coupled in a wireless manner to a gateway to perform encryption/decryption functions. Therefore, the computer system 120 may further include a wireless communication chip (WiFi chip) 131.

Therefore, the embodiment of the present invention may be implemented as a non-temporary computer-readable storage medium in which a computer-implemented method or computer-executable instructions are recorded. When the computer-readable instructions are executed by a processor, the instructions may perform the method according to at least one aspect of the present invention.

In accordance with the present invention having the above configuration, a power versus efficiency table contained in the CPU of a system may be generated, and the optimal operating frequencies for all loads may be selected based on such a table, thus maximizing the power efficiency of the system.

The present invention proposes an inherent characteristic-based optimal CPU frequency selection scheme which exhibits the optimal power versus performance of the CPU used in various types of IT equipment, thus enabling the selection of the frequency optimized for hardware from the standpoint of the OS.

Since the power versus efficiency characteristics of hardware that is executed are taken into consideration, the present invention may be executed in a form optimized for specific hardware, despite having a general-purpose scheme.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A Central Processing Unit (CPU) frequency scaling apparatus, comprising:
a table generation unit for generating, for all cores, a power versus efficiency table, based on available frequencies for respective cores and power consumption values depending on loads at each frequency;
an average load measurement unit for calculating an average load on all the cores; and
a frequency determination unit for searching the power versus efficiency table for an optimal frequency, based on load information calculated by the average load measurement unit and current power consumption of all the cores, and determining a found optimal frequency to be a new operating frequency.

2. The CPU frequency scaling apparatus of claim 1, wherein the frequency determination unit determines the optimal frequency found from the power versus efficiency table to be the new operating frequency, based on the load information calculated by the average load measurement unit and the current power consumption of all the cores depending on whether a powersave governor has been activated.

3. The CPU frequency scaling apparatus of claim 2, wherein the frequency determination unit is configured to if the powersave governor has been activated, determine, based on the load information calculated by the average load measurement unit and the current power consumption, a certain frequency to be the new operating frequency, wherein the certain frequency exhibits power efficiency, which matches the load information and the current power consumption, in the power versus efficiency table.

4. The CPU frequency scaling apparatus of claim 3, wherein the frequency determination unit is configured to select a single candidate frequency from the power versus efficiency table based on a current operating frequency and current power consumption, compare power efficiencies of the candidate frequency and frequencies lower than the candidate frequency, and if the candidate frequency is determined to be optimal, determine the candidate frequency to be the new operating frequency.

5. The CPU frequency scaling apparatus of claim 3, wherein the frequency determination unit is configured to select a single candidate frequency from the power versus efficiency table based on a current operating frequency and current power consumption, compare power efficiencies of the candidate frequency and frequencies lower than the candidate frequency, and if a frequency having better power efficiency is determined to be present among the lower frequencies, determine a corresponding lower frequency to be the new operating frequency.

6. The CPU frequency scaling apparatus of claim 2, wherein the frequency determination unit is configured to, if the powersave governor has not been activated, set an operating frequency of each core to a maximum frequency.

7. The CPU frequency scaling apparatus of claim 1, wherein the frequency determination unit applies the new operating frequency to each core through a CPU driver.

8. The CPU frequency scaling apparatus of claim 1, wherein the table generation unit is configured to, if the power versus efficiency table is not present in a database when the corresponding apparatus starts to operate, generate a power versus efficiency table and store the generated power versus efficiency table in the database.

9. The CPU frequency scaling apparatus of claim 1, wherein the average load measurement unit calculates an average load on all the cores during a predetermined period of time, based on a working time and an idle time of the corresponding apparatus.

10. A Central Processing Unit (CPU) frequency scaling method, comprising:
generating, by a table generation unit, for all cores, a power versus efficiency table, based on available frequencies for respective cores and power consumption values depending on loads at each frequency;
receiving, by a frequency determination unit, an average load on all the cores calculated by an average load measurement unit depending on whether a powersave governor has been activated; and
searching, by the frequency determination unit, the power versus efficiency table for an optimal frequency, based on the average load and current power consumption of all the cores, and determining a found optimal frequency to be a new operating frequency.

11. The CPU frequency scaling method of claim 10, wherein receiving the average load on all the cores comprises receiving the average load on all the cores calculated by the average load measurement unit if the powersave governor has been activated.

12. The CPU frequency scaling method of claim 11, wherein determining to be new operating frequency comprises:
selecting a single candidate frequency from the power versus efficiency table, based on a current operating frequency and current power consumption;
comparing power efficiencies of the candidate frequency and frequencies lower than the candidate frequency; and
if the candidate frequency is determined to be optimal as a result of the comparison, determining the candidate frequency to be the new operating frequency.

13. The CPU frequency scaling method of claim 11, wherein determining to be the new operating frequency comprises:
selecting a single candidate frequency from the power versus efficiency table, based on a current operating frequency and current power consumption;
comparing power efficiencies of the candidate frequency and frequencies lower than the candidate frequency; and
if a frequency having better power efficiency is determined to be present among the lower frequencies as a result of the comparison, determine a corresponding lower frequency to be the new operating frequency.

14. The CPU frequency scaling method of claim 10, further comprising:
applying, by the frequency determination unit, the new operating frequency to each core through a CPU driver.

15. The CPU frequency scaling method of claim 10, wherein generating the power versus efficiency table comprises, if the power versus efficiency table is not present in a database when a corresponding apparatus starts to operate, generating a power versus efficiency table.

16. The CPU frequency scaling method of claim 10, wherein the average load on all the cores is calculated based on a working time and an idle time of a corresponding apparatus.
